(19) United States
(12) Patent Application Publication
(10) Pub. No.: US 2010/0177045 A1
(43) Pub. Date: Jul. 15, 2010

(54) Fixing Structure for Rackmount Keyboard Drawer

(76) Inventor: Limo Lu, Taipei County (TW)

Correspondence Address: SHOU - HSIN YIN, P.O. BOX 90-3 Taipei, TAIPEI City, 10699, TW

(21) Appl. No.: 12/351,801

(22) Filed: Jan. 9, 2009

(51) Int. Cl. G06F 3/02

(52) U.S. Cl. 345/168

(57) ABSTRACT

A structure for fixing a keyboard in a slidable support of a rack for industrial computers is disclosed. A preferred embodiment includes a seat and a keyboard. There is an embedding recess for receiving the keyboard in the seat. A side of the keyboard is provided with an output port for connecting with a connecting port of the seat, and an electric connection is established between the two ports by a pressing element exerting pressure over them. The two ports are located in a depression being closely adjacent to one side of the embedding recess. The depression can be selectively covered by a panel.

### BACKGROUND OF THE INVENTION

1. Field of the Invention

The invention relates to industrial computers, more particularly to rackmount keyboards of industrial computers.

2. Related Art

Conventional rackmount industrial computer devices, such as workstations, monitor/keyboard supports, RAIDs and KVMs, are superposed in a rack. Two lateral sides of each of such devices are provided with sliding rails, which allow the devices to slidably move in the rack for operation or maintenance. With the popularization of liquid crystal displays (LCDs), keyboards 12 of some industrial computers are pivotedly connected with an LCD monitor 11 as shown in FIGS. 1 and 2. Two lateral sides of the keyboard 12 are separately provided with two sliding rails, each of which is composed of a rail rod 13 and a rail frame 14. Thus, the keyboard/monitor support 10 is slidably arranged in a rack 20 and electrically connected to a host computer (not shown) through a hub 21 at the rear. Such a structure has been used for a long time. However, the keyboard 12 is embedded in a recess of a seat 15 and is covered by a panel 16 for fixing. Both a soft wire at the rear of the keyboard 12 and a connecting port of the seat 15 are pressed by a pressing element to tight connect each other for outputting signals of the keyboard 12 and receiving electric power. Such a structure for connection is not good enough. Because, usually, environment where industrial computers are applied is hard or inclement, vibration of machines and condition of air will disadvantageously affect the connection. Meanwhile, the soft wire will also tend to be deformed or spoilt due to a long-term press. Thus, the keyboard 12 must be frequently replaced for maintaining normal operation. It is very inconvenient and uneconomical for users. Furthermore, the keyboard 12 is embedded in the recess and pressed by the panel 16, so if a user wants to remove the keyboard 12 from the rack 20, he/she must remove the monitor 11 first, and then remove many screws 151 fastening the panel 16 on keyboard/monitor support 10 (there must be “many” screws in an industrial computer). The panel 16, screws 151 and monitor 11 must be reinstalled after a new keyboard has been replaced. Accordingly, the replacement of keyboard 12 is considerably minute and complicated, and the computer must also cease work during the replacement procedure.

Additionally, keys of a keyboard are usually marked input symbols or codes for languages other than English such as Chinese, Arabic and Japanese. Manufactures of industrial computers must frequently replace a keyboard which has been installed in a support with another one marked different language symbols or codes. The replacement costs can be effectively reduced if the replacement procedure can be simplified or shortened.

### SUMMARY OF THE INVENTION

A primary object of the invention is to simplify and quicken replacement of keyboard in a rack.

Another object of the invention is to shorten the working hour required by a replacement procedure.

To accomplish the object, the present invention provides a structure for fixing a keyboard in a slidable support of a rack for industrial computers, which includes a seat and a keyboard. There is an embedding recess for receiving the keyboard in the seat. A side of the keyboard is provided with an output port for connecting with a connecting port of the seat, and an electric connection is established between the two ports by a pressing element exerting pressure over them. The two ports are located in a depression being closely adjacent to one side of the embedding recess. The depression can be selectively covered by a panel.

### BRIEF DESCRIPTION OF THE DRAWINGS

FIG. 1 shows a conventional keyboard/monitor support installed in a rack;

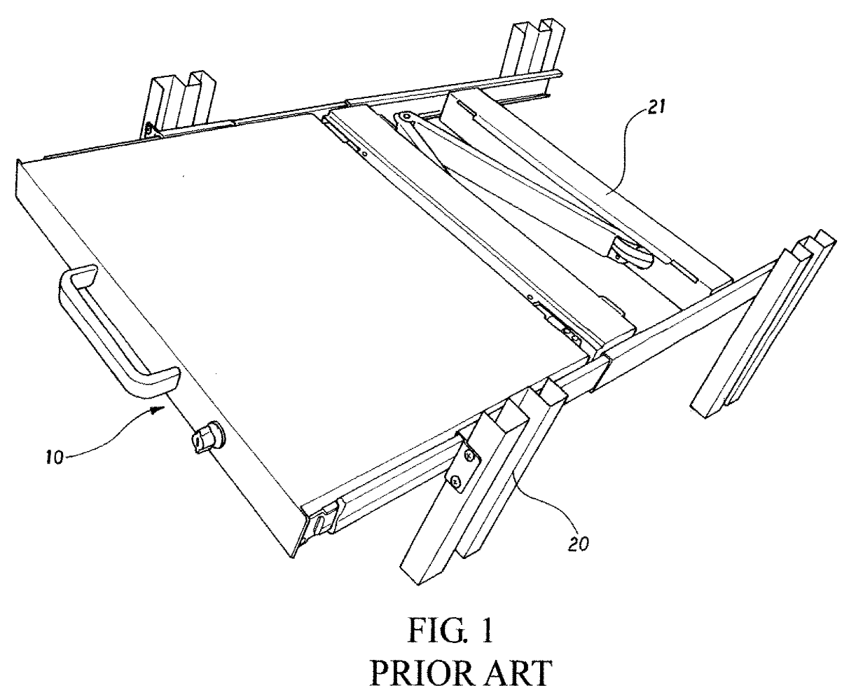

FIG. 2 shows the conventional support of FIG. 1 in open status;

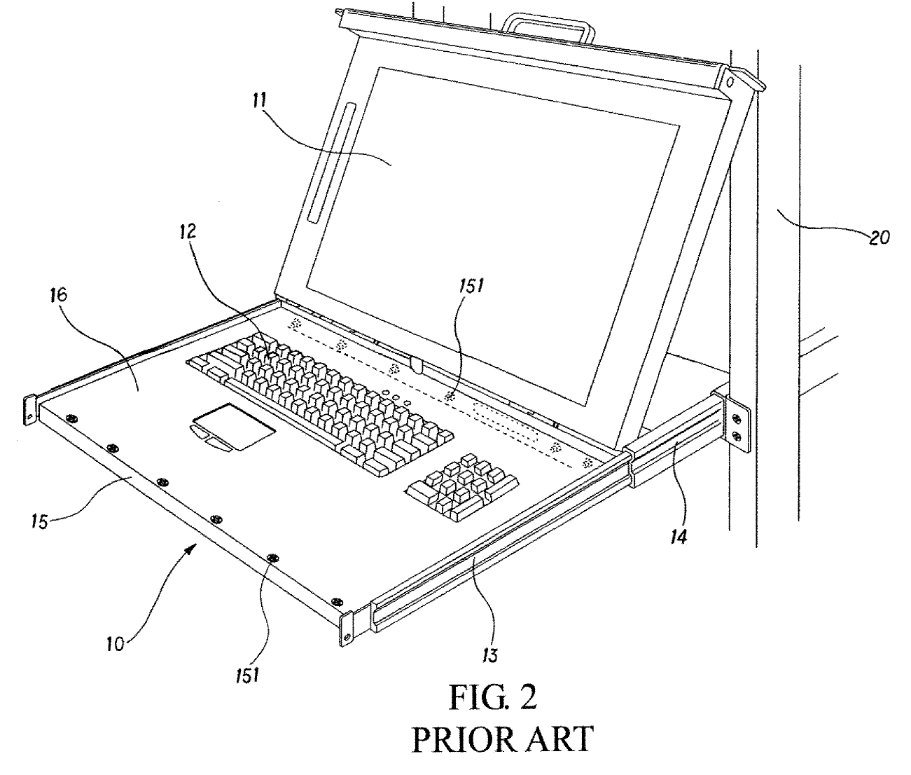

FIG. 3 is an exploded view of a preferred embodiment according to the invention;

FIG. 4 shows how the keyboard is embedded in the seat;

FIG. 5 shows how the pressing element presses the output port and connecting port;

FIG. 6 shows how the panel covers the depression;

FIG. 7 is a perspective view of the preferred embodiment shown in FIG. 3; and

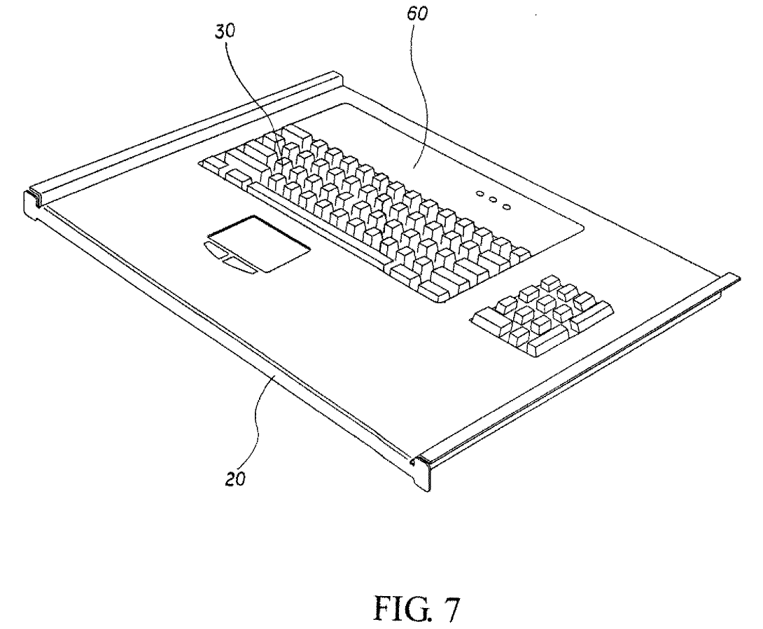

FIG. 8 shows another preferred embodiment according to the invention.

### DETAILED DESCRIPTION OF THE INVENTION

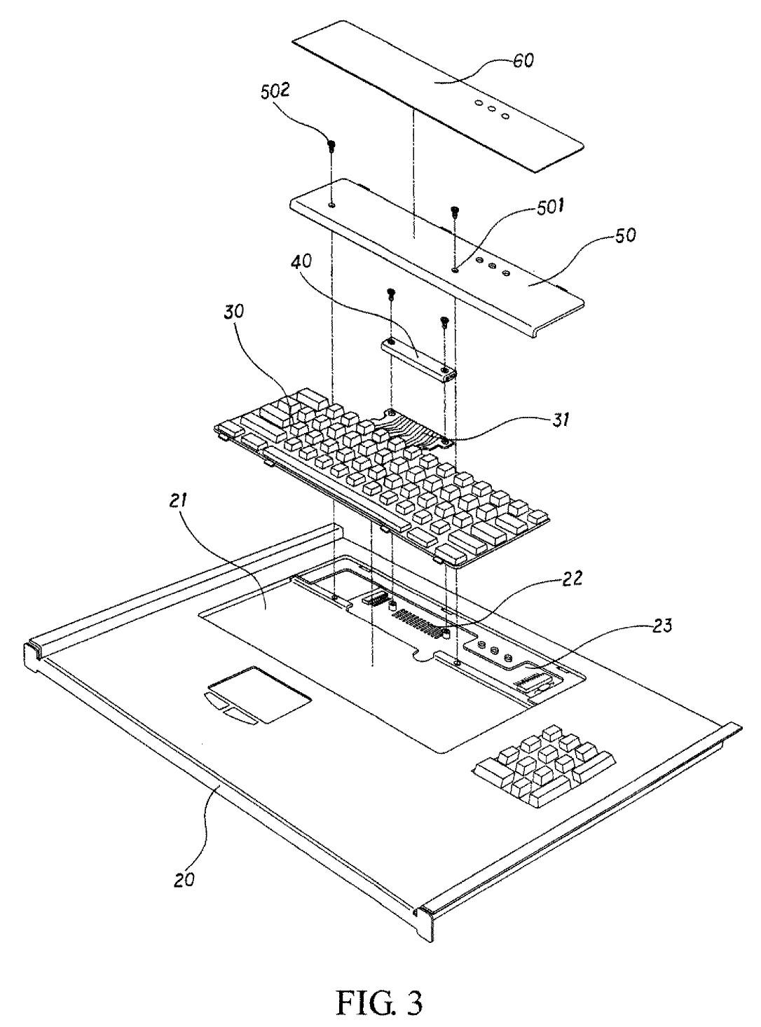

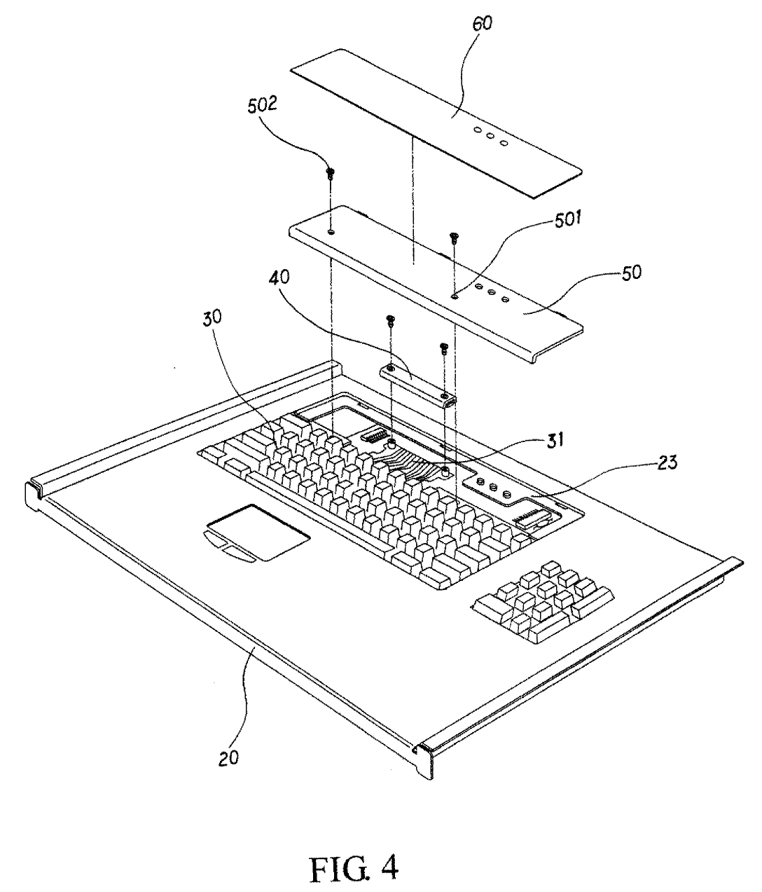

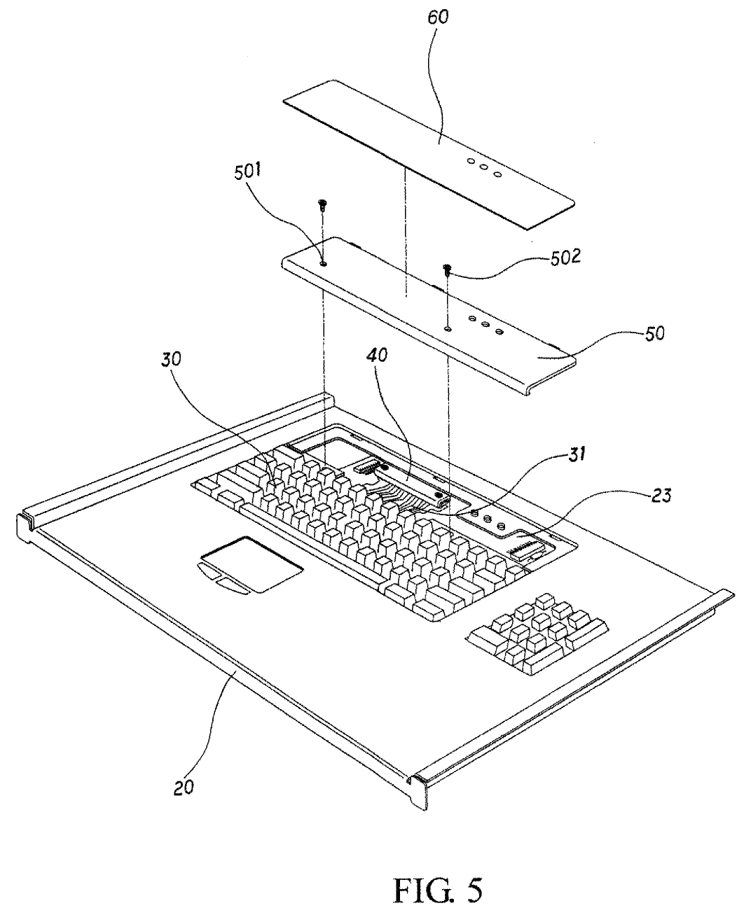

Referring to FIGS. 3 and 4, a preferred embodiment according to the invention includes a seat 20 and a keyboard 30. There is an embedding recess 21 for receiving the keyboard 30 in the seat 20. A side of the keyboard 30 is provided with an output port 31 for connecting with a connecting port 22 of the seat 20, and an electric connection is established between the output port 31 and connecting port 22 by a pressing element 40 exerting pressure over them. The output port 31 and connecting port 22 are located in a depression 23 being closely adjacent to one side of the embedding recess 21. A panel 50 covers the depression 23 and meets one side of the keyboard 30. The panel 50 can selectively cover or remove from the depression 23. The pressing element 40 is used for pressing the output port 31 and connecting port 22. The pressing element 40 can be exposed as shown in FIG. 5 or covered by the panel 50.

In the preferred embodiment shown in the drawings, the panel 50 is provided with one or more holes 501 for being passed through by fastening elements 502 to fasten the panel 50 on the seat 20, so that the panel 50 can cover the depression 23. Certainly, the keyboard 30 can be removed to replace by disassembling the fastening elements 502 and pressing element 40. It is very simple and quick. Also, the panel 50 can fixed on the seat 20 by hooks or hinges. They can provide the function of quick release.

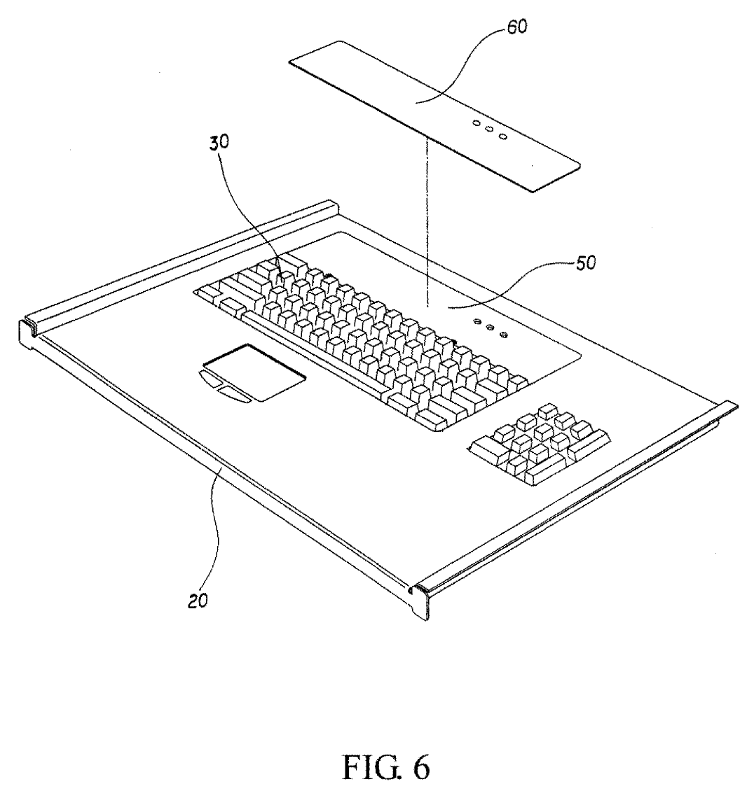

Moreover, to increase artistry of panel 50 and to improve integrality between panel 50 and seat 20, an outer surface of the panel 50 can be additionally provided with a film 60 by adhesion, coating or printing as shown in FIGS. 5 and 6. The panel 50 is coplanar with surface of the seat 20 for more completely covering the depression 23 to form a gapless visual effect.

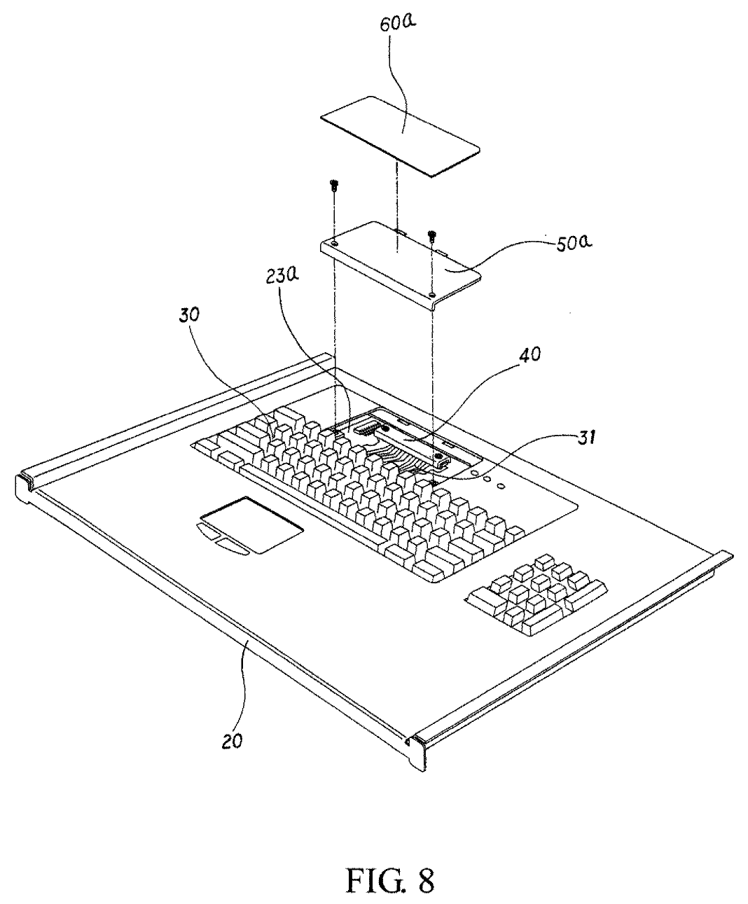

FIG. 8 shows another preferred embodiment according to the invention. Keyboard 30, seat 20, embedding recess 21, output port 31, connecting port 22 and pressing element 40 are the same as the abovementioned embodiment. The difference is that the area of depression 23a and panel 50a are smaller in size. The smaller depression 23a and panel 50a still can provide enough space for pressing element 40. Similarly, a film 60a can be disposed on the smaller panel 50a.

What is claimed is:

1. A fixing structure for rackmount keyboard drawer comprising:
a seat having an embedding recess and a connecting port;
a keyboard embedded in the embedding recess, having an outputting port connected to the connecting port by a pressing element;
a depression being closely adjacent to one side of the embedding recess, and the output port and the connecting port being located in the depression; and
a panel, removably covering the depression and the pressing element being exposed without the panel or covered by the panel.

2. The fixing structure for rackmount keyboard drawer of claim 1, wherein the panel meets one side of the keyboard.

3. The fixing structure for rackmount keyboard drawer of claim 1, wherein the panel is provided with one or more holes for being passed through by fastening elements to fasten the panel on the seat.

4. The fixing structure for rackmount keyboard drawer of claim 1, wherein an outer surface of the panel is provided with a film.

5. The fixing structure for rackmount keyboard drawer of claim 1, wherein the panel 50 is coplanar with a surface of the seat.
